(19) United States
(12) Patent Application Publication
(10) Pub. No.: US 2007/0220103 A1
(43) Pub. Date: Sep. 20, 2007

(54) Targeting personalized content to mobile users

(76) Inventors: Michael Rogers, Pleasanton, CA (US); Mark Young, San Jose, CA (US)

Correspondence Address: HAYNES BEFFEL & WOLFELD LLP, P O BOX 366, HALF MOON BAY, CA, 94019, US

(21) Appl. No.: 11/375,520

(22) Filed: Mar. 14, 2006

(51) Int. Cl. G06F 15/16

(52) U.S. Cl. 709/217

(57) ABSTRACT

A method of providing content to users of mobile devices. The process includes first the step of identifying a user population, including the sub-steps of assembling contact information regarding the members of the user population and assembling preference information concerning the members of the user population. The process further includes the step of assembling a content library, including the steps of storing selected content items in a central access point; cataloging selected attributes of each catalog item; and deriving a subset of users and content items. by matching items in one such group with selected members of the other group, based on selected criteria. The process finally includes the step of communicating content to user members of the identified group.

### BACKGROUND OF THE INVENTION

The invention relates generally to the area of mobile content providers actively notifying device users, and in particular to the system and methods for creating a profile for each device user; using that profile to determine which content may be most appropriate for that user; and innovations around how the message is sent and presented to the user.

Mobile device users today have limited means for learning about and finding content available for their devices. Users are largely limited to watching specific television or radio advertising, browsing service provider web portals, or most often searching a provider's content portal on their tiny screened devices. It is difficult for a user even to stay informed of content that may be new and interesting to her.

For example, radio, television, and print advertisements often provide a mechanism for mobile device users to visit a content aggregator site, separate from the user's own service provider content portal. One problem with this approach, however, is that a particular device may not be compatible with the content from the aggregator site, resulting in completely wasted effort. Service providers have intrinsic knowledge about the devices on their networks, and thus they can assuredly offer specific content to a mobile user which is known to be compatible with their devices. Content aggregators must advertise to an open market, which means they cover devices of all types, and customers of all service providers.

Another issue with bulk advertising is its level of granularity. It is possible to create advertisements which cover a particular genre of content, such as games or ring tones, as well as particular market segments, such as teens. The issue, however, is that it is not possible to advertise to a fine grained level of audience, such as “male teens who have previously bought a certain mobile role playing game”.

The current popular method of searching a service provider's content catalog from a mobile device's browser also has several limitations. Device screen sizes are relatively small and content catalogs are designed to show only a few choices on each page. Given the relatively high latency of today's cell networks and their average download speeds, this creates a rather poor viewing experience and a laborious, slow process for the user when browsing, previewing, and buying available content. Most users make it through only the first page or two before they quit browsing. Clearly, such situations present lost opportunities.

Given that many users only browse the first few pages of a service provider's content catalog, the best way service providers currently have for promoting new content is to place it directly on the first page, or on a special page linked from the first page. Also, there is typically little customization done to the page with regards to the details of the mobile device user who is browsing the page.

It would be desirable to have a system which can cross reference mobile device users' profile details with the content available, and proactively notify that user in a way the user finds convenient, non intrusive, and informative. It would also be desirable for such a system to meet users' expectations with regards to the security and privacy of their profile information.

### SUMMARY

In a method of personalizing the notifications of users about device content, sales characteristics about specific content are first identified. Those characteristics are then cross referenced with user profile information which is located and accessed. Users with profile data which matches the desired characteristics can then be notified directly of the availability of the content. Users may also then refer such content to other users, such as those members identified in their device's address book.

User notifications may be through a variety of electronic and non electronic mechanisms, such as postal mail, electronic mail, instant message, device SMS or MMS, as well as a non standards-based direct device notification. Message notifications should be reflective of their content, including aspects of the message such as title, short description, logo, iconic representation, or content preview. Message notifications also should not interfere with the other standard uses of the device.

The frequency of such user notifications should be modulated in a way so as to not become a nuisance to the user, such as through user preferences, interaction with past notifications, past purchases, etc.

Finally, the system should be implemented in a secure and private manner such that user identifiable information is protected and user's expectations of such matters are met.

### BRIEF DESCRIPTION OF THE DRAWINGS

FIG. 1 generally depicts in schematic form an embodiment of the system of the present invention.

FIG. 2 illustrates the functionality of the content meta server, a component of an embodiment of the system of the present invention.

FIG. 3 illustrates the functionality of the user profile server, a component of an embodiment of the system of the present invention.

FIG. 4 illustrates the functionality of the user notification server, a component of an embodiment of the system of the present invention.

FIG. 5 illustrates the functionality of an embodiment of the system of the present invention.

FIG. 6 illustrates a method for integrating an embodiment of the present invention with a mobile device screen display.

FIG. 7 illustrates a method for providing content notifications to users, according to an embodiment of the system of the present invention.

FIG. 8 illustrates a method for content driven notifications to users, according to an embodiment of the system of the present invention.

FIG. 9 illustrates a method for user driven notifications, according to an embodiment of the system of the present invention.

### DETAILED DESCRIPTION

The following detailed description is made with reference to the figures. Preferred embodiments are described to illustrate the present invention, not to limit its scope, which is defined by the claims. Those of ordinary skill in the art will recognize a variety of equivalent variations on the description that follows.

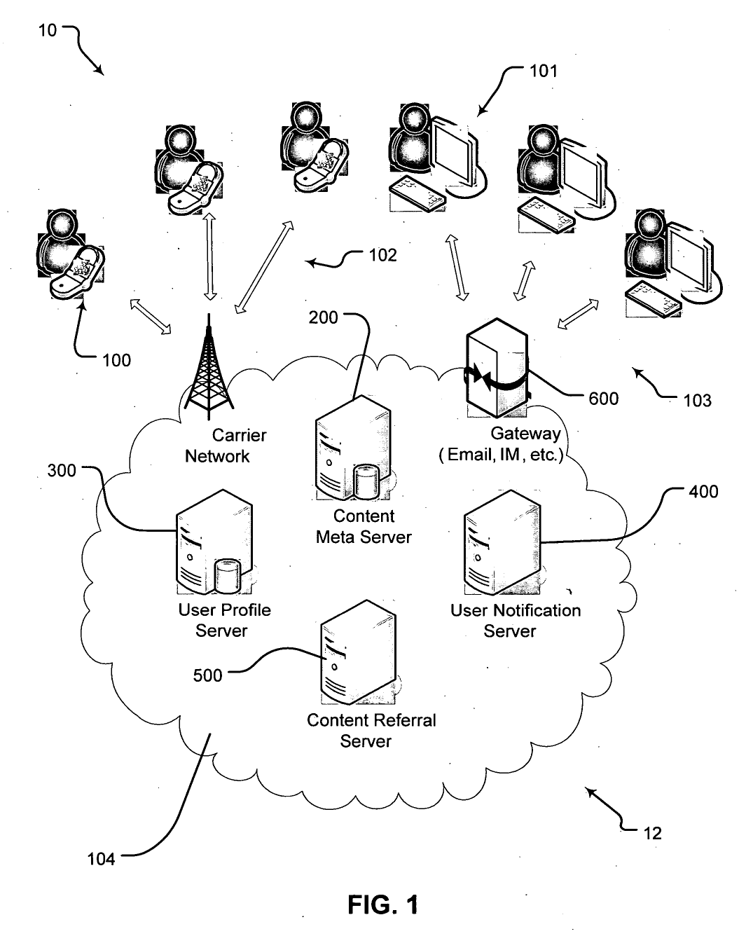

An embodiment of a network configured according to the claims herein is shown in FIG. 1. As shown, a multitude of users 10 are connected to a computer network 12 from two different types of devices, cellular phones 100 and desktop computers 101. The cellular phones connect using the wireless network 102 provided by the commercial carrier to which a particular cellular telephone subscribes. As is well-known in the art, such networks are commercially provided by companies such as Verizon, T-Mobile, etc. The desktop computers connect using a network 103, such as the internet or a dedicated broadband network. In some embodiments, the mobile devices may not be cellular handsets, they may be Personal Digital Assistants (PDAs) or even automobile navigation/entertainment systems. Also, the devices may connect using an alternate wireless mechanism, such as Wi-Fi, WiMAX, or satellite. It is anticipated that mobile and network technology will continue to evolve rapidly, and that new means and media of communication will be introduced. The principles set out herein can be implemented in a wide variety of such technological environments, and the communications means and media employed should not be understood as limiting the scope of the invention.

Central network functions are performed in network core 104. Although the various servers are shown as single, freestanding entities in FIG. 1, those in the art will understand that alternative embodiments can deploy such functionality in a variety of configurations. For example, one embodiment could implement all of the illustrated functions as coordinated processes on a single computer. Other embodiments could employ a combination of free standing servers, databases, and computer processes. The embodiment of FIG. 1 includes a network of servers and databases 104. The network may be a single physical network, or in other embodiments may be a collection of networks interoperating as one. The network core includes content metaserver 200, user profile server 300, user notification server 400, and content referral server. The network core preferably also includes interfaces to the mobile telephone carrier network 103 and the computer network 103, the latter being accomplished in one embodiment via a gateway server 600. The functionality of each of these components is discussed below.

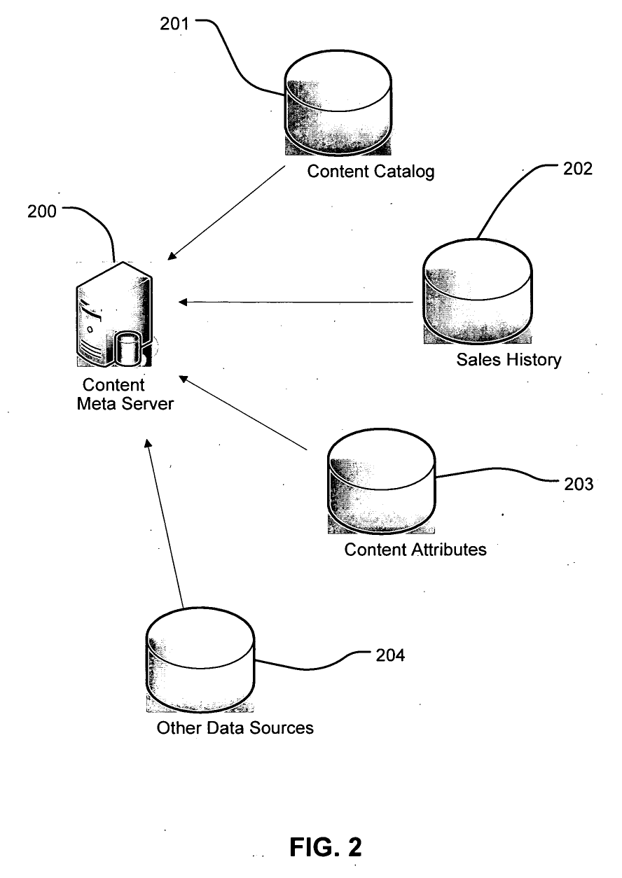

FIG. 2 provides a detailed diagram of the content metaserver 200. As used herein, “content” refers to text or graphic information, audio or audiovisual files, or executable files, that can be executed, listened to, or viewed on a mobile device. The content metaserver performs “content selection,” which thus refers to the process of selecting specific content for specific application instances by matching characteristics of such content with selected criteria

The content metaserver provides a single interface to comprehensive query information about mobile device content. For example, aggregated data could include a content item's title, type, genre, number of times it has been previewed, number of times it has been purchased, median age of purchasers, typical gender of purchasers, device requirements, promotional status, awards, reviews, etc. In one embodiment, a number of data sources are available for aggregation, including the existing content catalog 201, the recorded sales history of the content catalog 202, a database of attributes about the content 203, and finally any other data sources 204, such as user surveys, reviews, studies, or promotions. These data sources are depicted as individual databases, but in some embodiments these sources may reside in a single combined database, or any combination of combined and individual databases, as well as data entered directly into the content metaserver itself through some user interface.

As shown, the content metaserver 200 is implemented as an individual server and database, which collects information from other various data sources and then constructs a single unified relational database. The collection of available content could include content which is already available to the user, content which is newly available to the user, content which is available through the user's own service provider's content portal, as well as content which is available through third party content portals. Examples of content include ring tones, wallpaper, games, applications, services, videos, photos, television or movie programming, and music tracks.

The content selection process may be as simple as matching certain characteristics or as complex as utilizing mathematical and statistical methods, such as predictive analytics. Examples of matching simple characteristics could be:
For a mobile device game, select all those users who are male and within a certain age range
For a mobile device ring tone, select all those users who have purchased other ring tones of the same genre or by the same musical artist
For a mobile device wallpaper, select all those users who have previously purchased wallpapers of the same category
   Predictive analytics refers to more advanced statistical methods for data analysis. These methods include techniques such as predictive modeling, data mining and appraisal, machine learning, interest patterns, and simulations.

Any combination of these selection techniques may be utilized. Also, certain selection criteria may be applied on a weighted scale. That is, certain direct correlations may be weighted more than certain indirect or statistical correlations in order to arrive at a certain “score”. This score represents the degree of match between a search criterion and the content, with a higher score indicating a better match than a lower score. Scores may then be aggregated and sorted as a means for determining a set of users to receive notifications.

The reason for constructing the single relational database is to improve overall performance of the system, as the data can be aggregated in a single step and then stored for repeated query over some period of time. Some alternate embodiments may not have this performance requirement however, and the content metaserver may actively aggregate the information from its data sources on every query. This method has the advantage of not making a copy of the content information from the individual data sources, thus the data is always in sync and up to date with the original sources. However, this method may not be feasible or desirable for other reasons in some applications.

Technical implementation of the databases and associated techniques are known in the art. For example, databases may be commercially available databases from suppliers such as Oracle, Sybase, Microsoft or IBM, or open source database systems such as MySQL. Those in the art will understand the best adaptation of techniques to accomplish the results set out above.

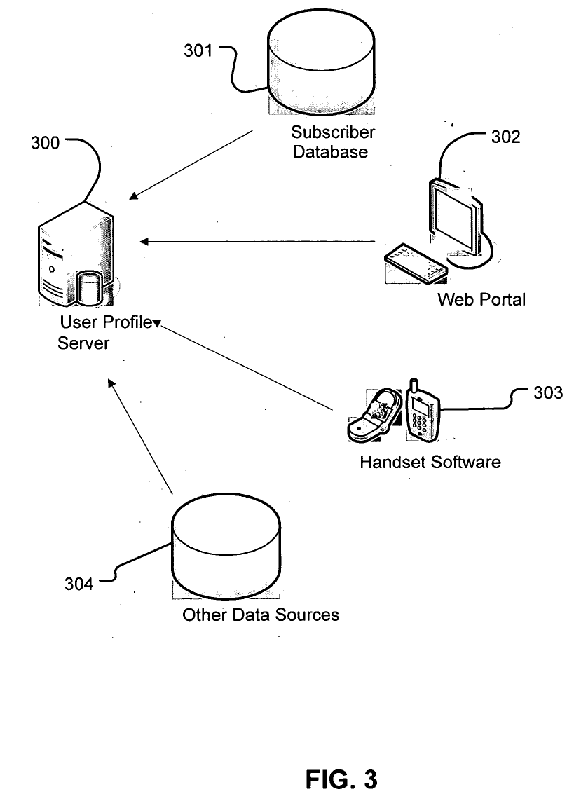

The user profile server 300 is shown in FIG. 3. This component provides a single interface to comprehensive query information about mobile device users. In the present context, a ‘user” is a person who subscribes to a mobile telephone service through a carrier. In one embodiment, the term “users” encompasses the group of subscribers to a single carrier's services. Other embodiments could offer a wider scope, and further developments in the mobile telecommunications business could bring other groupings. In general, the term “users” can be used to describe any set of mobile telephone subscribers about whom certain information, described below, is known.

A “user profile” is a collection of information about an individual user, including two types of data. The first type of information is that which is either already known by the service provider or inferred by known characteristics of the user. The second type of information is that which is explicitly provided by the user for the purpose of enhancing the profile.

Examples of the first type of user information are the following:
Gender
Age
Telephone number, including area code for possible location usage
Billing address, including zip code for possible location usage
Mobile device make, model, and capabilities, such as processor, software, screen size, number of colors, messaging ability, internet connectivity, camera, video capture, and location information
Calling and data plan, including utilization of the plan such as number of text messages sent and received, multimedia messages sent and received, downloads, and other purchases
Past response to such notifications as described in this invention, such as if the user expressed interest in the notifications, chose to continue to receive the notifications, and/or purchased content as a result of the notifications
Other identifiable attributes

Examples of the second type of user information are the following:
Specified preferences, as entered either via the mobile device itself or through a website using a standard desktop web browser
Affinities, loyalties, or brand affiliations, such as with sports teams, colleges, consumer brands, retail chains, restaurants, artists etc.
Education level, career, hobbies and interests, language, parental status, etc.
Other user-provided attributes

The information aggregated to form the user profile may be stored on any combination of a client or server in a typical client-server environment. The storage of such information should also adequately meet user's expectations of privacy and security.

For example, aggregated data could include a user's gender, age, postal address, area code, device type and capabilities, provider plan, purchased content, preferences, etc. Possible data sources to be aggregated include the service provider's existing subscriber database 301, user-provided preferences via a web portal 302, user-provided preferences via their mobile device 303, and finally any other data sources 304, such as past purchases, brand affiliations, or promotions. These data sources are demonstrated as individual databases, however in some embodiments these sources may reside in a single combined database, or any combination of combined and individual databases, as well as data entered directly into the user profile server itself through some user interface.

In the same manner as the content metaserver described above, the user profile server 300 is implemented as an individual server and database, which collects information from other various data sources and then constructs a single unified relational database. The reason for constructing the single relational database is to improve overall performance of the system, as the data can be aggregated in a single step and then stored for repeated query over some period of time. Some alternate embodiments may not have this performance requirement however, and the user profile server may actively aggregate the information from its data sources on every query. This method has the advantage of not making a copy of the user information from the individual data sources, thus the data is always in sync and up to date with the original sources. However, this method may not be efficient or desirable for other reasons in some applications.

Although user profile information is linked to real world users and their information, it should be noted that there may not necessarily be a 1-to-1 correspondence of profiles to users. For example, some embodiments may employ “meta profiles”—composite profiles which reflect particular user segments composed of many real world users, not a single specific user. For example, it could be useful in some embodiments to have profiles which represent all male, teenage, game players. Or, for instance, a meta-profile could represent all middle age, female, heads of household. The user profile server should be thought of as a relational database which can create and present user profiles based on individual query information. The correspondence of those profiles to actual users may be dependent on the query performed as well as the data structures and design of the profile server itself.

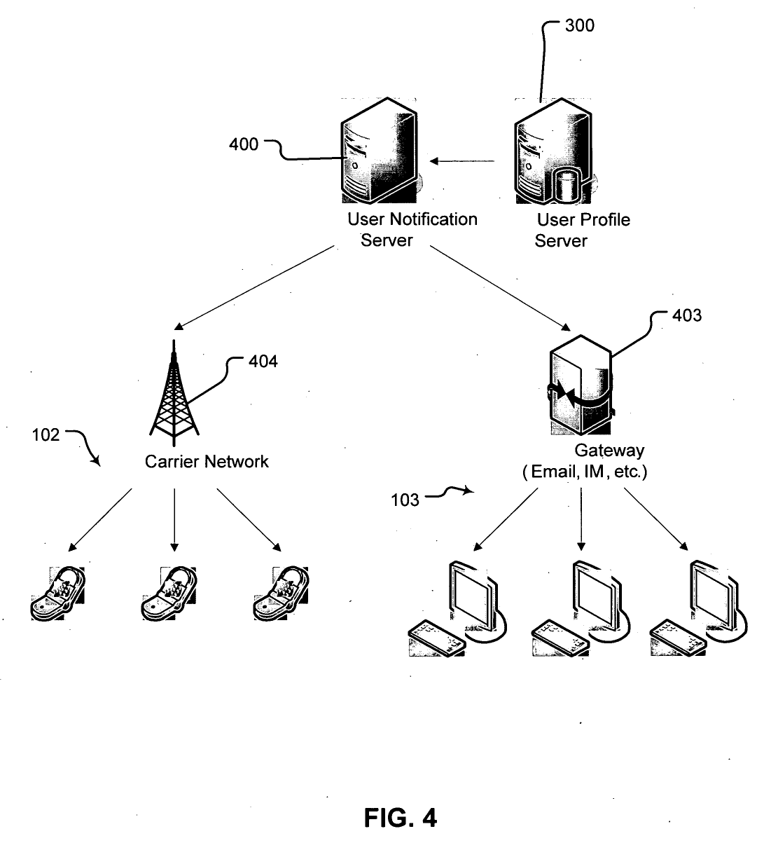

The user notification server 400 is depicted in FIG. 4. This component provides a single interface to a comprehensive set of user notification services. In the example depicted, for example, once the decision has been made to send a notification to a user, the system must identify the best means of notifying the user and then utilize whatever communication servers or gateways are required.

Possible communication mechanisms to be aggregated include the service provider's wireless network 102 as well as various internet protocols 103. In the event that the communication is sent directly to mobile devices, the carrier's facilities 404 are employed, with the carrier providing the interface between computer-based and telephone-based communication. Using those facilities, the system can notify the user directly on a mobile device using SMS, MMS, or some proprietary handset message format. If it is desired to utilize a broadband network such the internet, a gateway server 403 is employed. In that event, the communication can be sent via email or instant messaging. Alternate embodiments may choose to notify the user by other communications media, such as postal mail, RSS feeds, or other popular notification methods. It is expected that the user notification server 400 will consult with the user profile server 300 to determine the user's desired means of notification. It is also possible that the user notification server may notify a user using one or some combination of several different communication media.

The user notification server 400 is depicted as a single logical server. In other embodiments, however, the user notification server will likely be a gateway to several other specialized communications servers. For example, the user notification server may interact with a separate SMS server to notify the user wirelessly using an SMS, or a separate email server to notify the user via email. The intent of the user notification server component in the invention is to serve two purposes: one as a literal abstraction of all the types of user communication mechanisms that may be available, and second as a distinct process step to retrieve and observe a user's desired notification preference. Other embodiments may omit this abstraction and first query the user's preference, then contact the desired communications server (such as SMS, email, etc) directly. These changes will be well within the scope of those having ordinary skill in the art.

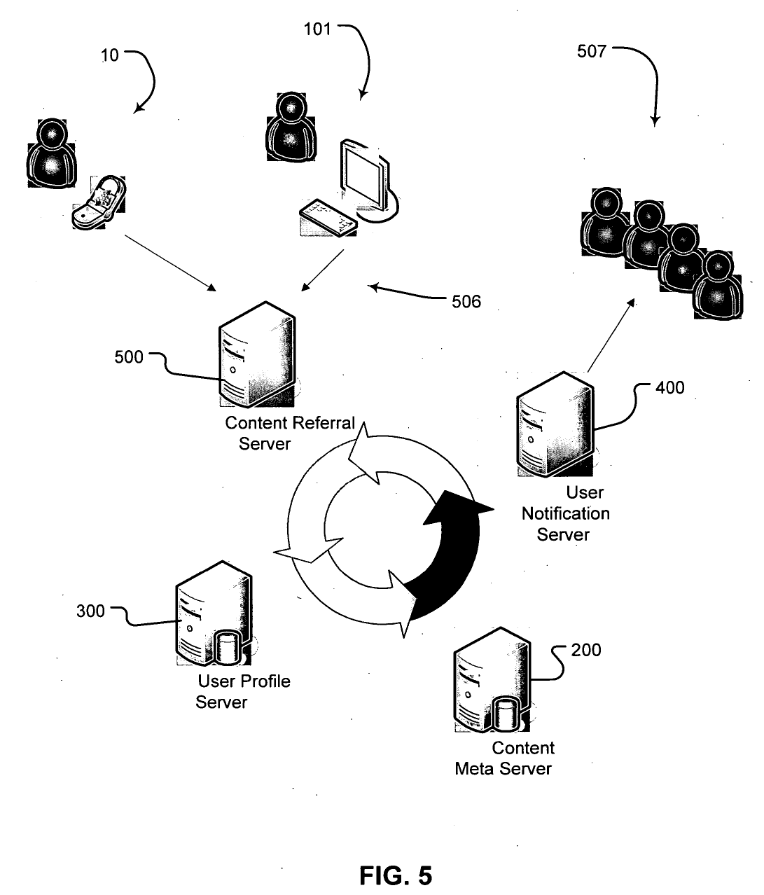

FIG. 5 ties the content referral server 500 to the previously-mentioned components to form a system. The content referral server allows users to tell others about content they enjoy or have found useful. To assist users in this process, the system will provide a list of people to receive notifications about the content. The content referral server represents the logical component in the system which receives a list of users to receive notifications, the content for which to notify, and then proceeds with the task of referral.

The diagram illustrates how users can initiate referrals from both mobile devices 10 and their desktop computers 101, through the system and on to receiving users 507. In other embodiments, users may initiate referrals from other devices, such as PDAs or automobile displays, via messages 506 from their devices to the network. Once on the network, such messages are forwarded to content referral server 500. In other embodiments, users may also receive notifications through several other mechanisms, such as their mobile devices or desktop computers. Referral notifications are sent to users in the same manner as for regular content notifications, which method is detailed fully in the discussion of the user notification server, above. The motivation for users to provide content referrals may be varied. For example, users may be given rebates, discounts, refunds, awarded points, prizes, etc.

When content referral server 500 receives a request to send a referral notification, it utilizes other components of the system to structure and communicate a referral list to whom the content should be forwarded. First, it first communicates with user profile server 300 to determine if the users in the referral list are known to the system. If the users are not known to the system, they may be members of a separate service provider. Depending on the content to be referred, users on service providers other than the originating service provider may or may not be contacted with the referral notification. The reason for this is that for users outside of the originating service provider, it may not be possible to determine their type of device, the capabilities of the device, nor access to the content from the device.

After the list of referral users is finalized, the content metaserver 200 is used to cross reference device requirements for the referred content with the device characteristics of the users in the referral list. This is an important aspect, as it is desirable to avoid notifying a user about content which the user's device cannot operate (a user receiving such a notification would become frustrated and disenfranchised with the system).

Finally, the user profile server 300 is utilized, initially to determine each user's desired means of notification. Then, the user notification server 400 notifies each receiving user 507 in the referral list about the content. The originating user may also be notified at this time with the results of the referral task. Over a period of time, subsequent referrals may also trigger notifications to originating users. For example, if a user refers content to others, and those refer it yet again, eventually originating users may accrue extra rebates, refunds, etc., warranting a notification which could occur at some point in the future significantly later than the original content referral.

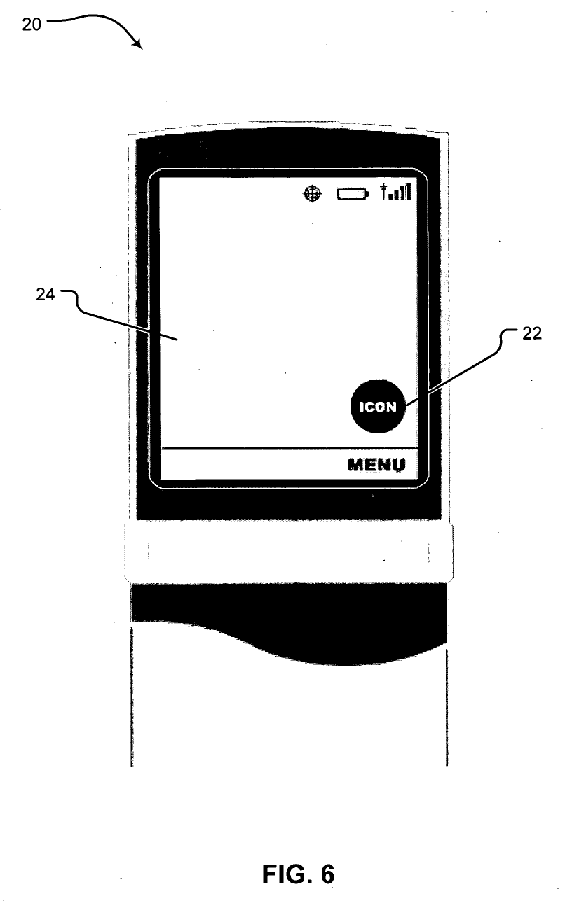

One aspect of the embodiment shown here is the method for gaining the attention of a mobile user. It will not be desirable to confuse the arrival of content from the present system with a telephone call, so the user must be able to distinguish the two events. FIG. 6 diagram illustrates the manner in which a specific type of proprietary device notification is made, where the receiving device is a mobile handset 20. The nature of this embodiment is to place an easily recognizable, and ideally informational, icon 22 on the device's “phonetop” 24. A mobile handset's “phonetop” is the default screen which the user sees when the phone is opened (for clamshell phones, often a key press for other style phones). The phonetop is also referred to as the “idle” screen and is typically adorned with some wallpaper the user has selected.

The message notification icon is displayed as an overlay on the phonetop 24. The placement and sizing of the icon should be appropriate for the device's screen size as well as the language and even the culture of the user. For example, users with left-to-right languages may expect the icon to appear in the lower right corner of the display. Users with right-to-left languages may expect the icon on the left of the display, either at the top or at the bottom.

The message icon itself should be representative of the notification. For example, if the notification was regarding game content, the icon may well be an image from the game itself, or possibly the logo of the company which created the game (assuming the logo is readily recognizable by users). Other possibilities could be genre based icons, such as a generic “game” logo for games, an “audio” icon for ring tones, a “picture” icon for wallpapers, etc. Notifications which are referrals from other users may have their own special identifier, such as an additional “buddy” icon overlay. Branded content may also use images from the brand itself as a means for the user to readily recognize the origin of the content. The goal for this aspect of the invention is for users to both easily distinguish as well as perceive greater value to content notifications of this type over typical handset notifications such as SMS or MMS messages.

Message notifications which are not sent via this proprietary mobile handset mechanism should attempt to follow the same guidelines as best possible. For example, email notifications should have identifiable subject lines as well as graphical brand logos and previews within the message body itself. Other notification mediums should use whatever means best accomplishes this goal.

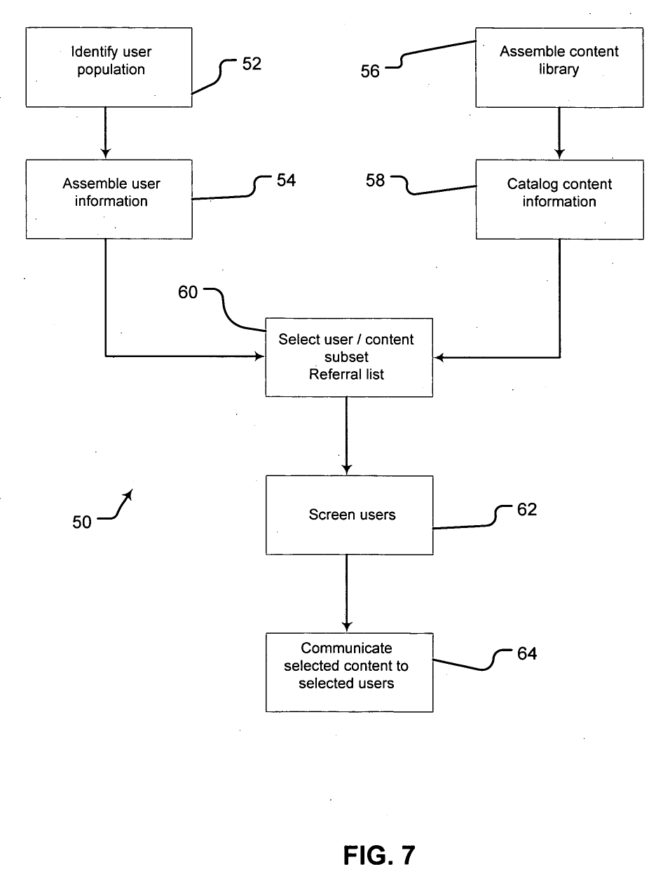

The general method 50 employed to provide content notifications to users is illustrated in FIG. 7. On independent tracks, user information is assembled to form databases of user and content information. User information is identified in step 52 and assembled into usable form (such as database 301, FIG. 3) in step 54. Independently, content is gathered into a library (such as content catalog 201, FIG. 2) in step 56. Content allows more work with the data, such as working with sales history database 202 and content attributes database 203 (FIG. 2), during the data preparation step 58. The system combines these sources in step 60 to select subsets of users and content to meet a particular need. The user list is screened to ensure suitability, in step 62, and then the notifications are sent to users in step 64.

The following two flowcharts illustrate two different utilization scenarios for the present invention. These scenarios are by no means exhaustive, and other embodiments are certainly possible in which the components of the invention are utilized in various orders and configurations for the purpose of generating personalized content notifications to users.

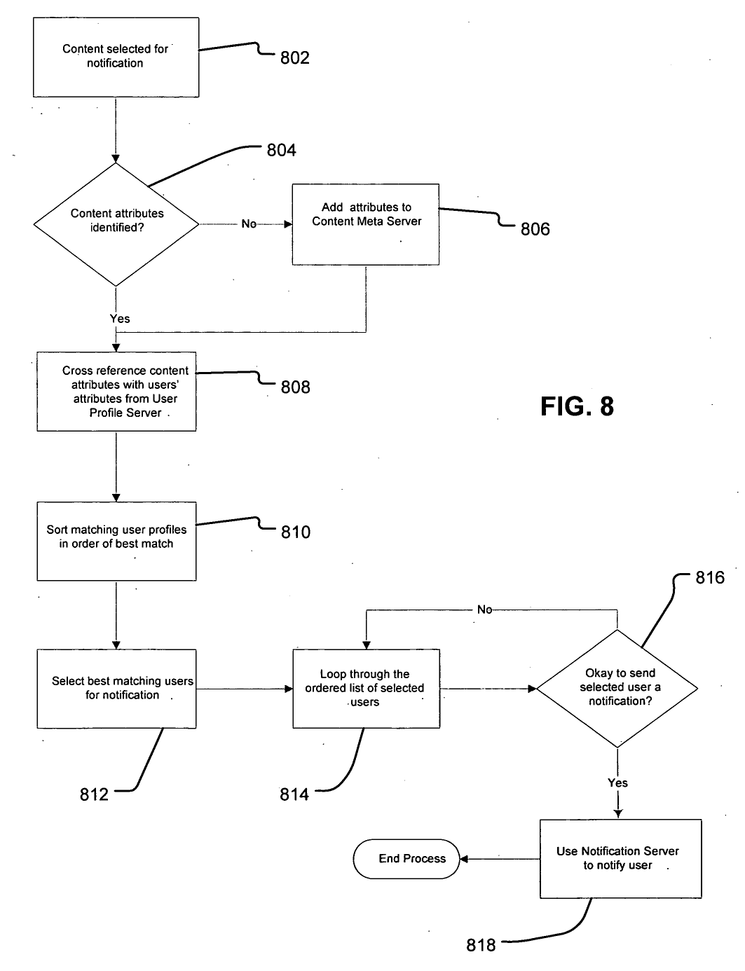

The flowchart of FIG. 8 depicts a content driven notification. That is, the process is initiated by first selecting content from the content catalog 700, and considerations surrounding that content determine other characteristics of the actions taken. The process of selecting the content for notification may be accomplished by any of several different ways. For example, new content may be added to the catalog, or content may be selected based on sales criteria or popularity, or selection may be based on which content has recently received awards, or any other such mechanism. Each step of this diagram may be accomplished by any combination of automated computer process and interactive user input.

Before selecting users for notification, attributes of the content are identified in step 802. If attributes of the content have not yet been identified, that step is accomplished (step 804) and the attributes are added to the content metaserver.

Examples of content attributes to be identified could be as follows:
If a title is a new version of a previous title, those attributes which were assigned to the previous title are added to the new title.
If a title is a game, attributes which identify the game's genre and other playing characteristics are specified. For example, if the game's genre is heavily favored by males versus females, that attribute is identified. If the game's playing characteristics favor a particular age range or geographic location, those attributes are identified.
If a title is a ring tone, attributes associated with the artist of that ring tone are then associated with the title, such as music genre, average fan age, gender, etc. The title may further be identified with even more specialized attributes such as ‘Top 40’, or ‘Billboard Top 100’, or ‘Grammy Winner’, etc.
If a title is a wallpaper, attributes associated with the producer of that wallpaper are then associated with the title. For example if the wallpaper is from a particular artist, magazine, brand affiliation, sports team, etc., that attribute is identified and can be used to find users with an affinity for such an attribute.

These examples are not exhaustive, but are meant to convey the types of attributes which are identifiable for content titles. The goal is to identify suitably interesting attributes which can then be cross-referenced with the existing knowledge base of users.

Once attributes of the content have been identified, they are cross referenced with data in the user profile server, in step 808. The user profile server contains attributes associated with individual users in the system, as well as meta profiles associated with a multitude of users.

The comparison of attributes between the content and the user profiles is then sorted in order of best to worst match, in step 810. There are a multitude of algorithms, mathematics, statistical and analytical models which may be used in order to rank the match of various user profiles with the content. One embodiment of representing the match of a user profile with the content is by means of a numerical score. A higher score would indicate a better match than a lower score. In this matter, scores may be sorted from highest to lowest.

After scores have been sorted, the best matching users are then selected to receive notifications about the content, step 812. The number of users chosen to receive notifications may be based on a threshold value for their content match score, or by some other means. The list of selected users is checked in step 814 and each user's profile is checked to ensure the user should receive the notification, step 816. Considerations for this step could be the user's preference to not receive such notifications, an inadequate amount of time since the user last received a notification, or some other consideration. It is important to note at this step the nature of frequency of notifications. If a user receives content notifications too frequently, they may be inclined to either not receive such notifications at all or will otherwise ignore the notifications. One aspect of this invention is to identify thresholds for such frequencies and utilize them in determining when a user is ready to again receive notifications. After determining which users in the list should receive the notification, the user notification server actually sends the personalized content notifications to each user, in step 818. At this point, the process ends.

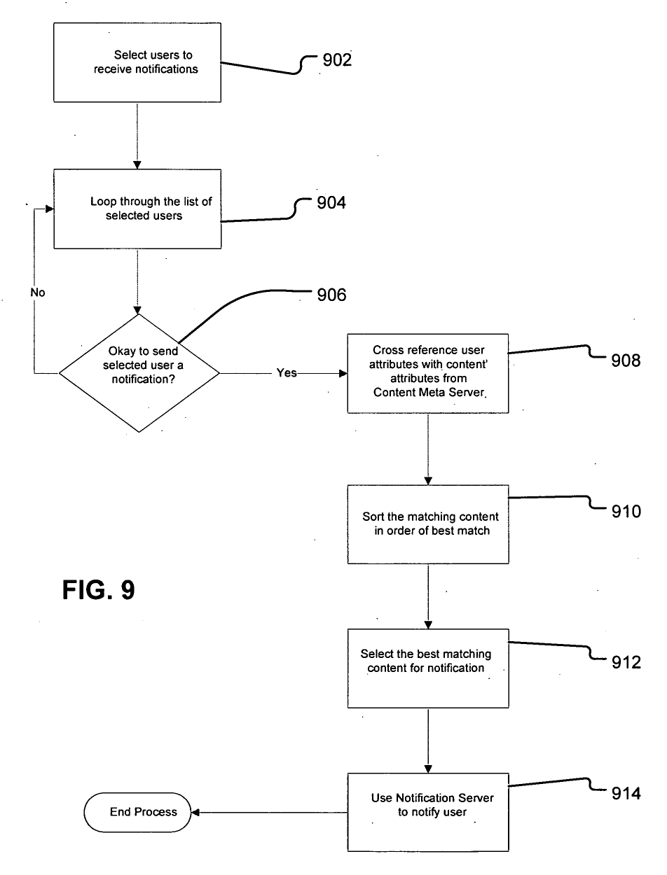

The flowchart of FIG. 9 illustrates the converse process, a user driven notification. That is, the invention is initiated by selecting a set of users to receive notifications, in step 902. The criteria for selecting users to receive notifications are generally based on marketing considerations, and such criteria may thus touch on a number of factors. Examples can include new users joining the service provider; users who have not purchased previously; users who have not purchased recently; users who have been referred by another user; or similar concepts. Each step of this diagram may be accomplished by any combination of automated computer process and interactive user input.

The list of selected users is first iterated in step 904, and each user's profile is checked to ensure the user should receive the notification, in step 906. As set out above in connection with the content-driven process, considerations for this step could include a user's preference not to receive such notifications, or an inadequate amount of time since the user last received a notification, or some similar consideration.

Once the list of users to receive notifications has been finalized, each user's profile attributes are cross referenced with data in the content metaserver (FIG. 2), step 908. The content metaserver contains attributes associated with all content available in the system.

The comparison of attributes between the content and the user profiles is then sorted in order of best to worst match, step 910. A multitude of algorithms, mathematics, statistical and analytical models exist, any suitable one of which may be used to rank the match of various user profiles with the content. Those of skill in the art will be able to select and manipulate such methods to achieve the desire result. As was true for the content-driven process, one embodiment of representing the match of a user profile with the content is by means of a numerical score. A higher score would indicate a better match than a lower score. In this matter, scores may be sorted from highest to lowest, as shown in step 910.

After scores have been sorted, the best matching content is then selected to generate notifications to users, in step 912. The content titles chosen to generate notifications may be based on a threshold value for their user profile match score, or by some other means. At this point, the user notification server actually sends the personalized content notifications to each user, in step 914, after which the process ends.

The preceding description of embodiments is meant to illustrate the nature of the invention and some of its immediate applications. It is, however, not meant to be exhaustive, as there are several areas in which modifications can be made. Though the invention is specifically demonstrated in the area of mobile phones, it may also apply to other mobile communications devices, such as PDAs or even automobile displays. The embodiments chosen should adequately enable those skilled in the art to understand and apply the invention appropriately to such devices.

We claim as follows:

1. A method of providing content to users of mobile devices, comprising the steps of:
identifying a user population, including the steps of,
assembling contact information regarding the members of the user population;
assembling preference information concerning the members of the user population;
assembling a content library, including the steps of,
storing selected content items in a central access point;
cataloging selected attributes of each catalog item;
deriving a subset of users and content items by matching items in one such group with selected members of the other group, based on selected criteria;
communicating content members of the subgroup to user members of the same.

2. A system for providing content to users of mobile devices, comprising:
a network core, including
a content meta server, including a database of content information and operatively connected to perform query actions regarding the same and to communicate the results of such queries;
a user profile server, including a database of user preference information and operatively connected to perform query actions regarding the same and to communicate the results of such queries;
a user notification server, operatively connected to perform user notification actions;
a content referral server, operatively connected to facilitate user referrals of desirable content;
wherein the network core communicates with communications systems for transmission to mobile telephone and internet users.

3. The system of claim 2, wherein the content meta server includes
a database of content information, including
content items;
metadata concerning content items, and;
user history items, and
an interface operatively configured to receive requests concerning content metaserver data, to form queries for the databases, to execute such queries, and to report the results of such queries.

4. The system of claim 2, wherein the user profile server includes
a database of user-related information, including
information known to an individual user's mobile service provider, and;
information provided by a user to enhance the content provided to that user;
a control system operatively configured to aggregate user data.

5. A method of providing content to users of mobile devices, comprising the steps of:
providing databases including content information and user information;
identifying a selected user population, including the steps of,
assembling contact information regarding the members of the user population;
assembling preference information concerning the members of the user population;
selecting users for which the system is authorized to provide a content notification;
cross-referencing attributes of the selected users with attributes of content in the content information database;
selecting content that matches attributes of the selected users; and
notifying the selected users regarding the availability of the matching selected content.

6. A method of providing content to users of mobile devices, comprising the steps of:
providing databases including content information and user information;
identifying content selected for distribution;
cross-referencing attributes of the selected users with attributes of content in the content information database;
selecting content that matches attributes of the selected users; and
notifying the selected users regarding the availability of the matching selected content.

7. A method of providing content to users of mobile devices, comprising the steps of:
identifying a user population, including the steps of,
assembling contact information regarding the members of the user population;
assembling preference information concerning the members of the user population;
assembling a content library, including the steps of,
storing selected content items in a central access point;
cataloging selected attributes of each catalog item;
deriving a subset of users and content items by matching items in one such group with selected members of the other group, based on selected criteria;
communicating content members of the subgroup to user members of the same
